(19) United States
(12) Patent Application Publication
(10) Pub. No.: US 2024/0164974 A1
(43) Pub. Date: May 23, 2024

(54) LIMB SUPPORT FOR ROBOTIC SYSTEM

(71) Applicant: Kevin Hollander, Scottsdale, AZ (US)

(72) Inventor: Kevin Hollander, Scottsdale, AZ (US)

(21) Appl. No.: 18/515,739

(22) Filed: Nov. 21, 2023

Related U.S. Application Data
(60) Provisional application No. 63/427,361, filed on Nov. 22, 2022.

(51) Int. Cl. A61H 3/00; B25J 9/00

(52) U.S. Cl. CPC A61H 3/00; B25J 9/0006; A61H 2003/007; A61H 2201/1642

(57) ABSTRACT

A limb support for a robotic system can comprise a first body that has a first end and a second end wherein the first end can extend to a transition wherein the transition can wrap around to the second end creating a radius. A plurality of holes can extend from the first end to the transition. At least two slots wherein a first slot can be substantially on the transition and the second slot is substantially on the second end. A strap can extend between the first slot and the second slot.

### CROSS REFERENCE

This application claims benefit from currently pending U.S. Provisional Application No. 63/428,361 titled “Limb Support for Robotic System” and having a filing date of Nov. 22, 2022, and all of which is incorporated by reference herein.

### FIELD OF THE INVENTION

The present specification relates generally to devices for supporting a limb and more specifically a device for supporting a human's limb for a robotic device.

### BACKGROUND OF THE INVENTION

Current exoskeleton usually provides multiple joints and actuators that control that joint, which are designed to be modular, and act as active joints for the user. These joints can be used for hips, knees, elbows, ankles, and shoulders. Certain features are typical throughout all systems such as, rigid frames that attach to the user by some type of support. These rigid frames and supports can be connected to a human's limb to help support and artificially strengthen that joint or limb during any type of movement. These movements can be walking, standing up, lifting or pushing a heavy object and motor impairment.

Typically, supports can be wrapped around the user's limb using hook and loop straps that are adjustable to the user's different size limb. These types of supports have padding consisting of foam or other soft material, and usually have some type of metal support connected to the exoskeleton link making the brace bulky and heavy for the user. These supports can leave sores and can be uncomfortable for the user. As a result, weight reducing designs have been employed to help make the brace lighter for the user, such as making the brace out of carbon fiber and using aluminum as the metal support. However, these weight reducing designs still require padding and hook and loop straps to keep the support in place on the user's limb making it hard for the user to remove the exoskeleton or can cause slippage on the user's skin resulting in blisters and sores.

Therefore, there is a need for a support that allows the user to support and clamp around the user's limb.

### BRIEF SUMMARY OF THE INVENTION

Accordingly, the present invention is a limb support for a robotic system can comprise a first body that has a first end and a second end wherein the first end can extend to a transition wherein the transition can wrap around to the second end creating a radius. A plurality of holes can extend from the first end to the transition. At least two slots wherein a first slot can be substantially on the transition and the second slot is substantially on the second end. A strap can extend between the first slot and the second slot. The first body can be manufactured from polycarbonate, plastic or a metal alloy. The strap can be fabric.

The first body can be in the shape of a J. The plurality of holes that can be coupled to a robotic system can have a joint with an actuator by at least one fastener. The strap cab be coupled to the first body by at least one buckle. The buckle can be a feed-through buckle, hinged buckle, or spring-loaded buckle. The strap loops through the buckles and couples itself creating secure structure for the user's limb to come into contact with.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is an isometric view of the limb support for a robotic system in accordance to one, or more embodiments;

FIG. 2 is a top view of the limb support for a robotic system in accordance to one, or more embodiments;

FIG. 3 is a back view of the limb support for a robotic system in accordance to one, or more embodiments;

FIG. 4 is a side view of the limb support for a robotic system in accordance to one, or more embodiments;

FIG. 5 is the other side view of the limb support for a robotic system in accordance to one, or more embodiments;

FIG. 6 is a front view of the limb support for a robotic system in accordance to one, or more embodiments;

FIG. 7 is a force diagram showing top view of the limb support for a robotic system in accordance to one, or more embodiments;

FIG. 8 is a force diagram showing top view in loose state of the limb support for a robotic system in accordance to one, or more embodiments;

FIG. 9 is a top view of another embodiment limb support for a robotic system in accordance to one, or more embodiments;

FIG. 10 is another force diagram showing top view of the limb support for a robotic system in accordance to one, or more embodiments;

FIG. 11a is a side view of the limb support for a robotic system on the user's thigh in accordance to one, or more embodiments; and

FIG. 11b is a side view of the limb support for a robotic system on the user's thigh bent in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

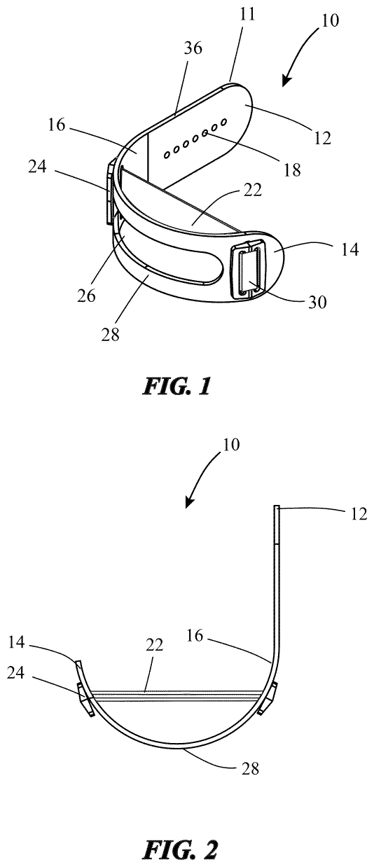

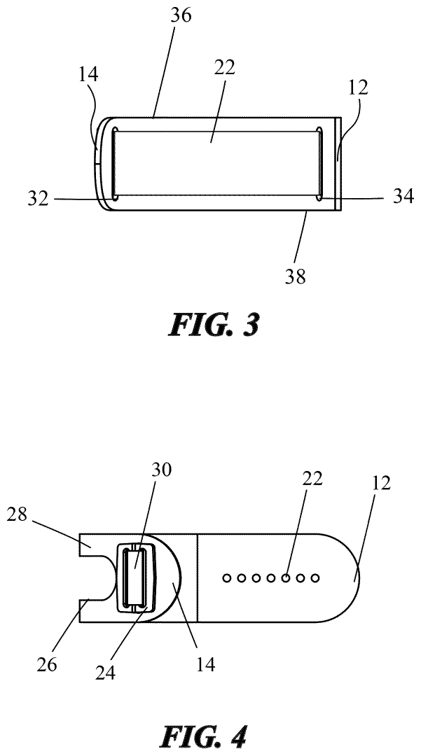

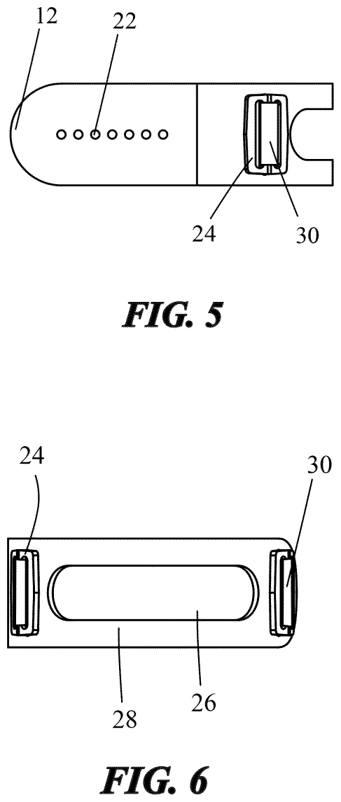

Referring initially to FIGS. 1-6, a limb support for a robotic system shown generally at 10. The limb support 10 can comprise a first body 11 having a first end 12 and a second end 14 having a top 36 and a bottom 38 wherein the top and the bottom can have a length between the two. The first end 12 can extend at a length such as for example 0.5 inches to at least 16 inches to a transition 16. The transition 16 can wrap around to the second end 14 creating a radius 28. The first end 12 can have plurality of holes 18 extending from substantially near the first end to the at or near the transition 16. The limb support 10 can have a constant thickness and in other embodiments the thickness can vary wherein the thickness cab be substantially around the holes, or the thickness can be the substantially near the top end 36 and the bottom end 38 as shown in FIG. 3. The first end 12, transition 16, radius 28 and second end 14 can have the same height and thickness or can be varying height and thickness. The first end 12 can be such as, for example, radiused, chamfered, cornered or the like, but in the preferred embodiment the first end is radiused. The limb support system 10 can be such as, for example, J-shaped, U-shaped, or the like, but can be any suitable shape known in the art. In certain embodiments the limb support 10 can be U-shaped wherein the radius 28 can have a load distributed along the radius which can clamp on the user's limb.

The limb support 10 can have at least one slot wherein the transition 16 can have a first slot 34 and the second end 14 can have a second slot 32. The first slot 34 and the second slot 32 can extend substantially near the top 36 and the bottom 38 leaving material connecting the transition 28 with the first end 12 and the second end 14. A strap 22 can extend from the first slot 34 to the second slot 32 wherein the strap can be attached to the first slot and the second slot by at least one buckle 24 wherein the buckle can be such as, for example, webbing buckle straps, feedthrough buckle, cam buckle, slide bar buckle, or the like. The strap 22 can extend through the first slot 32 and the second slot 34 and can be attached to the buckle. The strap 22 can wrap around the buckle and back through the slot overlapping itself wherein the strap can overlap itself as least once and in the preferred embodiment can overlap itself at least twice.

The strap 22 can be the interface with the user's limb and limb support and the robotic system. The strap creates an additional degree of freedom wherein the user's limb can move vertical and horizontal within the first body 11 which can in turn improve the user's comfort. The strap 22 can be made from such as, for example, fabric, elastic, nylon, or the like and in certain embodiments can be covered with a sheath, sleeve or coating of such as, for example, neoprene, foam, or the like. In certain embodiments the strap 22 and/or buckles 24 can be attached directly to the limb support 10. The strap 22 can have a loop and hook system coupled to it wherein the strap can wrap over around itself creating a distance between the strap and the first body 11 creating a user specified set tension on the strap or interface shape. The strap 22 can be placed and located anywhere on the limb support 10 wherein the strap can be in at varying distances from the first end 12 and the second end 14. FIGS. 1-8 shows the strap 22 as a straight line but the strap can be configured to have slack in it, thus holding the limb like a sling, or it can have an asymmetrical attachment points, straight portion attachment points, or the like.

In embodiments, the limb support 10 can be manufactured from one piece or multiple pieces and can be made of, such as, for example, plastic, metal, carbon fiber, poly carbonate, ceramic or the like or any combination thereof. In certain embodiments, the limb support 10 can be made from different materials such as, for example, the first end can be one material type, the radius 28 can be another, and the second end 14 can be another material type. In certain embodiments, the back side of the limb support 10 can have foam attached to it. The limb support can clamp around the user's limb when under a load from an outside system such as a robotic system and can unclamp when not loaded.

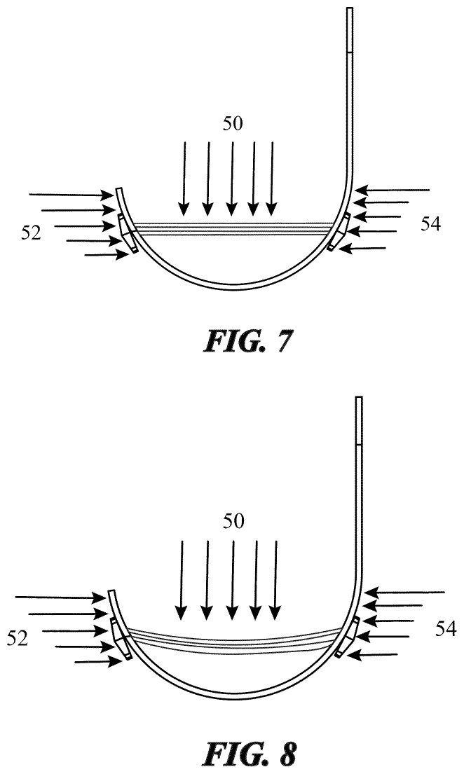

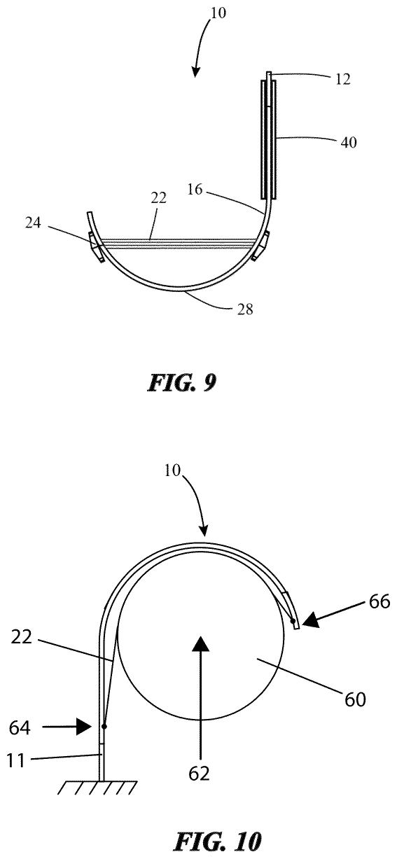

In other embodiments, the first slot 34 and the second slot 32 can be omitted and the strap 22 can be attached directly to the transition 16 and the second end 14 by such as, for example, adhesive, rivets, fasteners, or the like, or the buckles 24 can be formed into limb support 10. The first slot 24 and the second slot 32 can be straight across from each on the limb support 10 or they can be varying distances and angle on the first end 12 and the second end 14 and the transition 16, or radius 28. The first end 12 as it extends to the transition 16 can have a thickness or stiffener which can be manufactured into the part, or it can be added to the part by one or more fasteners as shown in FIG. 9. In addition, an embodiment could include a spring-loaded hinge joint at a point on 28 mounted in parallel and between slots 32 and 34, or simply between ends 12 and 14.
1. Referring to FIGS. 7-8 showing a force diagram for the limb support wherein as the user applies pressure on the strap 22, the strap pulls in on the buckles on the transition 16 and the second end 14. As the transition 16 and the second end 14 are compressed from the pressure applied form the strap 22 a pressure is applied to the user's limb, wherein as more pressure is applied the tighter the force is applied around the user's limb thus acting to the grip the limb when loaded and relaxed grip when not loaded. The strap 22 can reacts on a first end 12 and a second end 14 which clamps around a portion of the user's body or a portion of an accessory. The portion of the user's body can be a user's limb and/or the portion of the accessory can be a user's knee pad. The user's limb can be such as, for example, thigh, calf, forearm, bicep, upper arm, or the like and the accessory can be such as, for example, knee pad, arm pad, or the like.

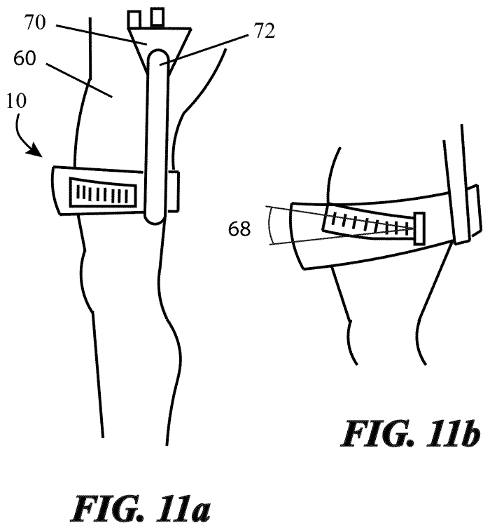

Referring to FIGS. 10-11b a top view and a side view of a limb support system 10 shown on a user. The user's limb 60 can be normal to, or perpendicular to the strap 22. The first body 11 and the strap 22 can support the user's limb and can allow the multiple angles of rotation such as horizontal, vertical, or any combination of rotation. The first body 11 can be attached to a fixed component such as, a robotic system with an actuator, or other movable system that helps strengthen or assist the user's limb. The strap 22 can create an additional degree of about the limb interface which can improve the wearer's comfort and allow the structure to tighten around the user's limb. The force 62 from user limb 60 can push against the strap 22 wherein the strap tension has a normal component load 64 and a normal perpendicular load 66 that can be the strap tension load. The limb support 10 and the strap 22 can have gap between the two allowing the limb to put force on the strap causing a normal force at the normal component load 64 and normal perpendicular load 66 per as shown in FIG. 11. As shown in FIGS. 12a and 12b as the user applies force from their limb 60 to the strap the angle of rotation 68 between the limb support 10 and the strap on the limb changes applying tightening the limb support 10 around the user's thighs.

A method of applying a limb support 10 for a robotic system comprising positioning a user's limb loosely within the limb support wherein the user's limb can come into contact with or be close to the strap and not within contact without a force loaded. Applying a force to the limb support wherein the force pushes the limb support against the user's limbs wherein the limb support applies a clamping force against the user's limb. The load can be released resulting in the release of the clamping force. The clamping force can be varied with the force applied by the robotic system. The strap can react on a first end and a second end which clamps around the user's limb.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claimed is:

1. A limb support for a robotic system comprising:
a first body having a first end and a second end wherein the first end extends to a transition wherein the transition wraps around to the second end creating a radius;
a first slot on the transition and the second slot on the second end; and
a strap extending between the first slot and the second slot.

2. The limb support according to claim 1, wherein the first body is manufactured from polycarbonate, plastic, or a metal alloy.

3. The limb support according to claim 1, wherein the strap is fabric or some other flexible and inextensible material.

4. The limb support according to claim 1, wherein the first body is in the shape of a J.

5. The limb support according to claim 1, wherein the plurality of holes that is coupled to a robotic system having a joint with an actuator by at least one fastener.

6. The limb support according to claim 1, wherein the strap is coupled to the first body by at least one buckle.

7. The limb support according to claim 6, wherein the buckle is a feed-through buckle, hinged buckle, or spring-loaded buckle.

8. The limb support according to claim 7, wherein strap loops through the buckles and couples itself creating secure structure for the user's limb to come into contact with.

9. The limb support according to claim 1, wherein the strap length is adjustable.

10. The limb support according to claim 1, wherein the first body can have a plurality of holes extending from the first end to the transition.

11. A method of applying a limb support for a robotic system comprising:
positioning a user's limb within the limb support wherein the user's limb come into contact with the strap without a force loaded;
applying a force wherein the force pushes the limb support against the user's limbs wherein the limb support applies a clamping force against the user's limb; and
releasing the load and the clamping force released.

12. The method of applying a limb support according to claim 11, wherein the clamping force varies with the force applied by the robotic system.

13. The method of applying a limb support according to claim 11, wherein the strap reacts on a first end and a second end which clamps around a portion of the user's body or a portion of an accessory.

14. The method of applying a limb support according to claim 13, wherein the portion of the user's body is a user's limb and/or portion of the accessory is a user's knee pad.
